(19) United States
(12) Patent Application Publication
(10) Pub. No.: US 2011/0277216 A1
(43) Pub. Date: Nov. 17, 2011

(54) FIBER MATERIAL

(76) Inventor: Alan Norman Higgins, Toronto (CA)

(21) Appl. No.: 12/779,417

(22) Filed: May 13, 2010

(51) Int. Cl. C09K 11/08; A42B 1/00; B32B 5/00

(52) U.S. Cl. 2/200.1; 252/301.36; 428/221

(57) ABSTRACT

There is provided a fiber material whose production is effected by contacting a fiber substrate with an operative composition. The fiber substrate includes optically active particulate materials supported on a support material. The operative composition comprises 0.1% to 10% cross-linking agent, 0.1% to 5.0% polyolefin, 0.1% to 5.0% wetting agent, 0.0% to 8.0% aminofunctional silicone, 0.0% to 6.0% ionizing agent, 0.0% to 2.0% catalyst, and includes a pH of between 2.0 and 4.0. Textile materials including the above-described fiber material are also provided.

### FIELD OF INVENTION

The present invention relates to novel fiber materials, and textile materials including such novel fiber material.

### BACKGROUND OF THE INVENTION

New fiber materials are being continuously developed with novel features. Recently, fiber materials have been developed which, when incorporated in textile materials for the manufacture of certain clothing articles, appears to increase blood flow in transcutaneous human tissues.

Recently, fiber materials have become available which appear to increase peripheral blood flow, and thereby, increase oxygenation, when such fiber materials are incorporated in garments which then are born and dispensed in contact with transcutaneous tissues. Examples of such fiber materials are described in U.S. Pat. No. 7,074,499, U.S. Patent Publication No. 2006/0234903, and U.S. Patent Publication No. 2009/0029614. It is desirable to improve on these materials so as to improve their functionality in increasing peripheral blood flow.

### SUMMARY OF THE INVENTION

In one aspect, there is provided a fiber material whose production is effected by contacting a fiber substrate with an operative composition, wherein the fiber substrate includes optically active particulate materials supported on a support material, and wherein the operative composition comprises 0.1% to 10% cross-linking agent, 0.1% to 5.0% polyolefin, 0.1% to 5.0% wetting agent, 0.0% to 8.0% aminofunctional silicone, 0.0% to 6.0% ionizing agent, 0.0% to 2.0% catalyst, and includes a pH of between 2.0 and 4.0.

### BRIEF DESCRIPTION OF THE DRAWINGS

The method and apparatus of the preferred embodiments of the invention will now be described with the following accompanying drawings:

FIG. 1 is a front perspective view of an embodiment of the headwear;

FIG. 2 is a front perspective view, partially cut-away, of the embodiment in FIG. 1, for purposes of illustrating an interior surface of the embodiment;

FIG. 3 is a bottom plan view of the embodiment in FIG. 1;

FIG. 4 is a front perspective view, partially cut-away, of the embodiment in FIG. 1, for purposes of illustrating certain features of an interior surface of the embodiment;

FIG. 5 is a front perspective view, partially cut-away, of the embodiment in FIG. 1, for purposes of illustrating certain other features of an interior surface of the embodiment;

FIG. 6 is a front perspective view, partially cut-away, of the embodiment in FIG. 1, for purposes of illustrating certain other FIG. 7 is a front perspective view, partially cut-away, of the embodiment in FIG. 1, for purposes of illustrating certain other features of an interior surface of the embodiment;

FIG. 8 is a front perspective view, partially cut-away, of the embodiment in FIG. 1, for purposes of illustrating certain other features of an interior surface of the embodiment;

FIG. 9 is a front perspective view, partially cut-away, of another embodiment of the headwear of the present invention, and similar to the embodiment in FIG. 1; and

FIGS. 10 and 11 are schematic illustrations of the textile materials used to manufacture the headwear of the present invention, showing the textile materials in two intermediate forms during the manufacturing process.

### DETAILED DESCRIPTION OF EMBODIMENTS OF THE INVENTION

There is provided a fiber material including a fiber substrate which has been contacted with an operative treatment composition.

The fiber substrate includes optically active particulate materials supported on a support material. It is believed that the optically active particulate materials, when combined with the fiber substrate, effect higher blood perfusion in areas of the human skin which are adjacent or in contact with the fiber substrate.

In some embodiments, for example, the fiber substrate is configured to absorb light at a first wavelength and re-emit light at a second wavelength (wherein the second wavelength is different from the first wavelength), and attenuates the light differently at different wavelengths to produce a filter with a desired wavelength distribution. In some embodiments, for example, the second wavelength is pre-selected.

In some embodiments, for example, a suitable fiber substrate is HOLOFIBER™ supplied by Hologenix, LLC, c/o Celliant of Santa Monica, Calif. (such fiber substrate is also sold under the name CELLIANT™). Examples of suitable fiber substrates are described in U.S. Pat. No. 7,074,499 issued to Schnurer et al., which is expressly incorporated by reference in its entirety herein.

In some embodiments, for example, suitable active particulate materials include one or more of silicon, carbon, and various vitreous glasses including oxides of aluminium, titanium, silicon, boron, calcium, sodium, and lithium. For example, suitable support materials include resins such as rayon, polyester, nylon, acrylic, polyamide and polyimide. Suitable materials, their selection, and their combination to produce the fiber substrate are described in U.S. Pat. No. 7,0784,499 from column 4, line 15 to column 8, line 62.

In some embodiments, for example, the fiber substrate includes aluminum oxide, silicon dioxide, and titanium dioxide.

For example, the active particulate material includes: (i) aluminium oxide (scallop-shaped particles having a particle size of 1.4 microns or smaller), for band shifting wavelengths of received light, (ii) silicon dioxide (substantially spherical particles, having a particle size of 1.5 microns or smaller), for shortening the wavelengths of received light, and (iii) titanium dioxide (triangular-shaped particles with rounded edges, having a particle size of 2.0 microns or smaller), for reflecting, absorbing and scattering the received light. The titanium dioxide, silicon dioxide, and aluminium dioxide are combined in a dry weight ratio of about 10:10:2, and the resultant fiber substrate includes 12 weight % of this composition of active particulate material based on the total weight of the operative material, after this active particulate material is combined and extruded with a suitable polymeric resin, such as polyester.

The operative treatment composition comprises 0.1% to 10% cross-linking agent, 0.1% to 5.0% polyolefin, 0.1% to 5.0% wetting agent, 0.0% to 8.0% aminofunctional silicone, 0.0% to 6.0% ionizing agent, 0.0% to 2.0% catalyst, and includes a pH of between 2.0 and 4.0. For example, the operative composition further includes a carrier. For example, with respect to the cross-linking agent, a suitable cross-linking agent is any of a polycarboxylic acid, a low molecular weight polymaleic acid, a copolymer of maleic acid and other monmers, citric acid, butanetetracaborlyxic acid, and mixtures thereof. For example, with respect to the polyolefin, the polyolefin is any of polyethylene, polypropylene, and mixtures thereof. For example, with respect to the wetting agent, the wetting agent is any one of non-ionic and anionic surfactants and mixtures thereof. For example, with respect to the aminofunctional silicone, the aminofunctional silicone is ionizeable, and is a silicone polymer including amine groups. For example, with respect to ionizing agent, the ionizing agent is any one of choline chloride, other reactive quarternary compounds, and mixtures thereof. For example, with respect to the catalyst, the catalyst is any one of sodium hypophosphite, sodium phosphate, sodium hydroxide, sodium carbonate, and mixtures thereof. For example, with respect to the carrier, the carrier is any one of water, air, alcohol, other water soluble compounds, and mixtures thereof, with or without water. For example, at least some aminofunctional silicone and/or ionizing agent is present to provide a desired ionized effect to the fabric. Other suitable exemplary operative treatment compositions are described in U.S. Patent Publication No. 2009/0029614 from paragraph [0024] to paragraph [0075]. U.S. Patent Publication No. 2009/0029614 is expressly incorporated by reference in its entirety herein.

With respect to the contacting of the fiber substrate with the operative treatment composition, in some embodiments, for example, the contacting is effected by any one of:
(a) spraying the operative composition onto the fiber substrate in a dense soaking mist to effect soaking through of the fiber substrate;
(b) applying the operative composition with the fiber substrate using an open paddle wheel; and
(c) applying the operative composition onto the fiber substrate in a pressure dye vessel.

In some embodiments, for example, the above-discussed fiber materials can be combined together by a spinning process, such as by that effected by a rotary spinning machine, to provide a yarn. The yarn can then be used to form fabrics, such as in the form of headwear 10. When incorporated in a fabric, any of the above-described fiber materials is referred to herein as the “operative material”.

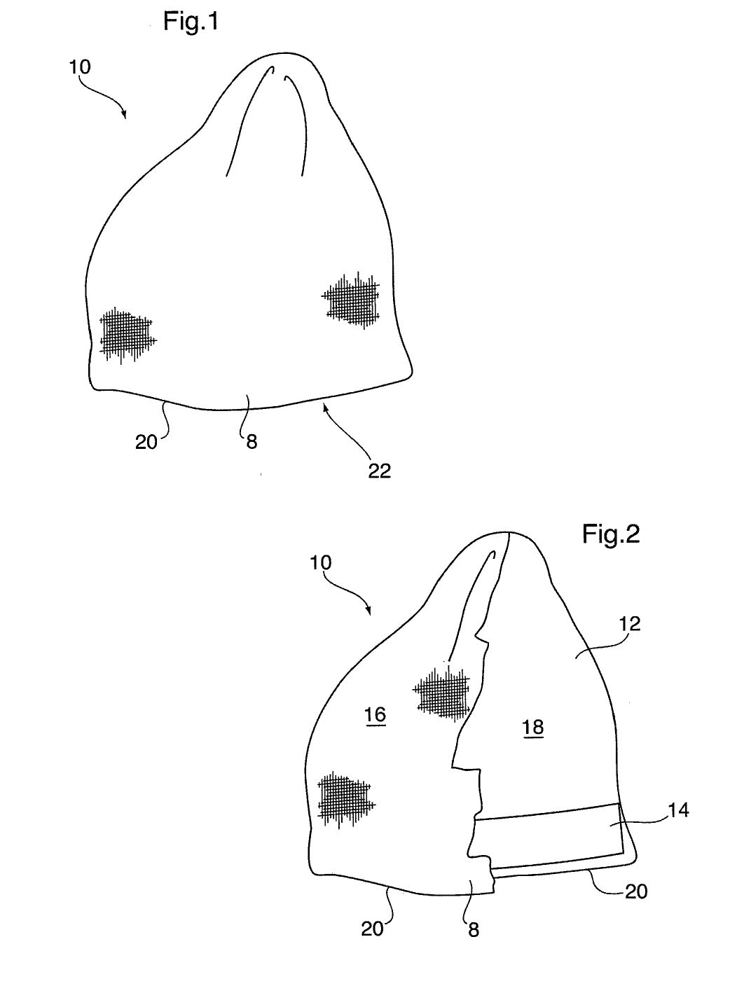

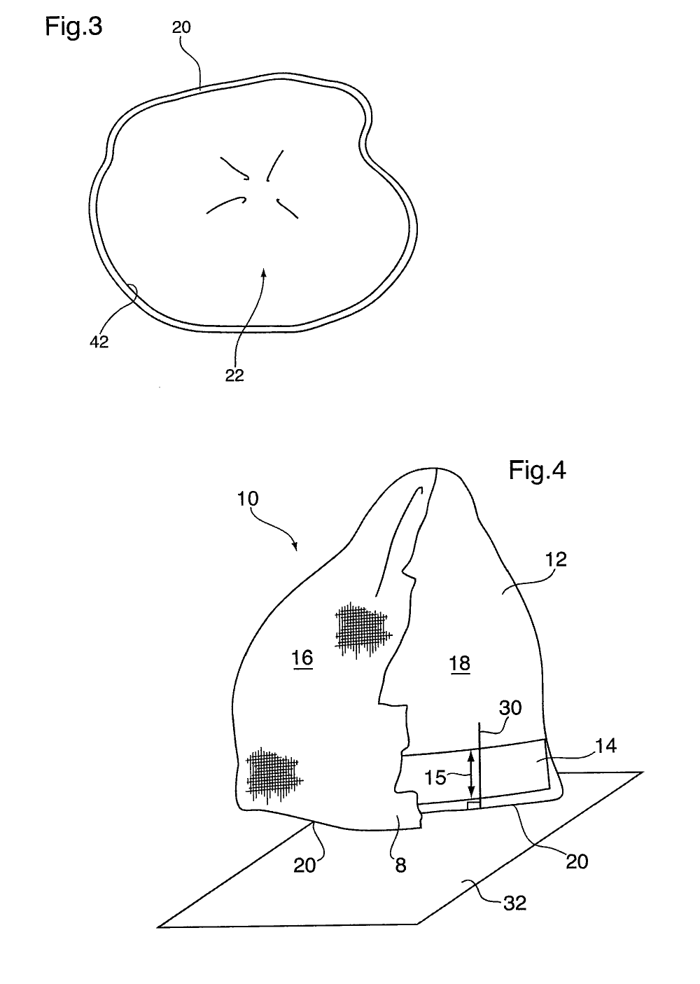

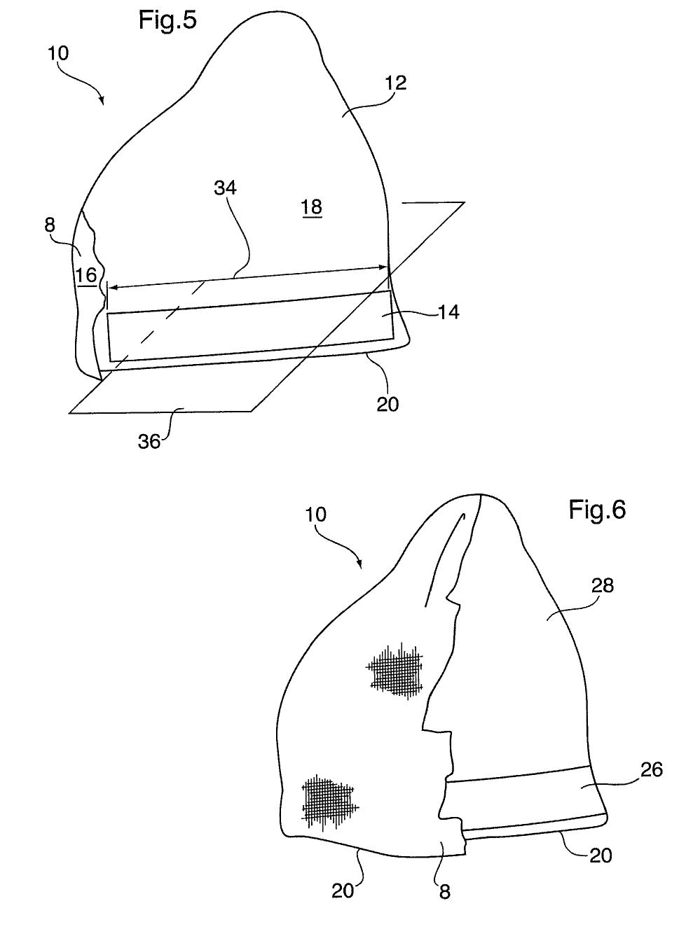

Referring to FIGS. 1, 2, and 3, the headwear 10 includes at least a head fitting portion 8. The head fitting portion 8 includes a shell 12. In the illustrated embodiment, the headwear 10 is in the form of a toque, which is also known as a “ski hat” or “skull cap”.

In some embodiments of the headwear 10, in addition to a head fitting portion 8, there is provided other features to increase the utilitarian value of the headwear. For example, where the headwear is a baseball-style cap, the head fitting portion is a crown portion, and there is further provided a visor coupled to the crown portion. As a further example, where the headwear is a sun visor, the head fitting portion is a rim portion, and there is also further provided a visor.

The shell 12 includes an exterior surface 16 and an interior surface 18. The exterior surface 16 is joined to the interior surface 18 at an edge 20. The edge 20 defines an opening 22 configured for receiving the head of a wearer of the headwear 10.

The shell 12 includes at least one operative shell portion. Each one of the at least one operative shell portion includes an operative shell portion exterior surface and an operative shell portion interior surface. Each one of the operative shell portion exterior surfaces defines at least a portion of the exterior surface of the shell 12. Each one of the operative shell portion interior surfaces defines at least a portion of the interior surface of the shell 12. Each one of the at least one operative shell portion is defined by an operative shell portion textile material.

In some embodiments, for example, the sum of the respective surface area of the operative shell portion exterior surface of each one of the at least one operative shell portion defines at least 15% of the surface area of the exterior surface 16 of the shell 12. In some embodiments, for example, the sum of the respective surface area of the operative shell portion exterior surface of each one of the at least one operative shell portion defines at least 15% of the surface area of the exterior surface 16 of the shell 12, and less than 50% of the surface area of the exterior surface 16 of the shell 12.

The operative shell portion textile material is any kind of textile material, including any fabric made through weaving, knitting, crocheting, or bonding, so long as the textile material includes greater than 10 volume % of the operative material based on the total volume of the operative shell portion textile material. In some embodiments, for example, the operative shell portion textile material consists essentially of the operative material.

In some embodiments, for example, the shell 12 includes a material band portion 14 which is defined by a material band portion textile material. A suitable material band portion textile material is any kind of textile material, including any fabric made through weaving, knitting, crocheting, or bonding, so long as the textile material includes at least 10 volume % of the operative material based on the total volume of the material band portion textile material. In some embodiments, for example, the material band portion textile material consists essentially of the operative material.

The material band portion 14 is disposed proximate to the edge 20, such that the material band portion 14 is configured to be disposed opposite to, and preferably in contact with, the head of a wearer of the headwear 10. In some embodiments, for example, the material band portion 14 extends substantially from the edge 20. In some embodiments, for example, the material band portion 14 is configured to extend above and behind the ears and across the forehead of a wearer of the headwear 10.

The material band portion includes a material band portion interior surface and a material band portion exterior surface. The material band portion exterior surface defines a portion of the exterior surface of the shell 12. The material band portion interior surface defines a portion of the interior surface of the shell 12.

In some embodiments, for example, the material band portion 14 defines at least 15% of the surface area of exterior surface 16 of the shell 12. In some embodiments, for example, the material band portion 14 defines at least 15% of the surface area of the exterior surface 16 of the shell 12, and less than 50% of the surface area of the exterior surface 16 of the shell 12.

Referring to FIG. 4, in some embodiments, for example, the material band portion 14 includes a minimum width of at least 1.5 inches measured along an axis 30 which is normal to the plane 32 parallel to the edge 20.

Referring to FIG. 6, in some embodiments, for example, the shell includes a lower portion 26 and remainder portion 28. Each one of the lower portion 26 and the remainder portion 28 includes a respective operative interior surface and a respective operative exterior surface. Each one of the respective operative interior surfaces defines a portion of the interior surface of the shell 12. Each one of the respective operative exterior surfaces defines a portion of the exterior surface of the shell 12.

The lower portion 26 includes at least one lower portion operative textile material portion 29. A suitable lower portion operative textile material portion is any kind of textile material, including any fabric made through weaving, knitting, crocheting, or bonding, so long as the textile material includes at least 10 volume % of the operative material based on the total volume of the lower portion operative textile material portion. In some embodiments, for example, the lower portion textile material portion consists essentially of the operative material.

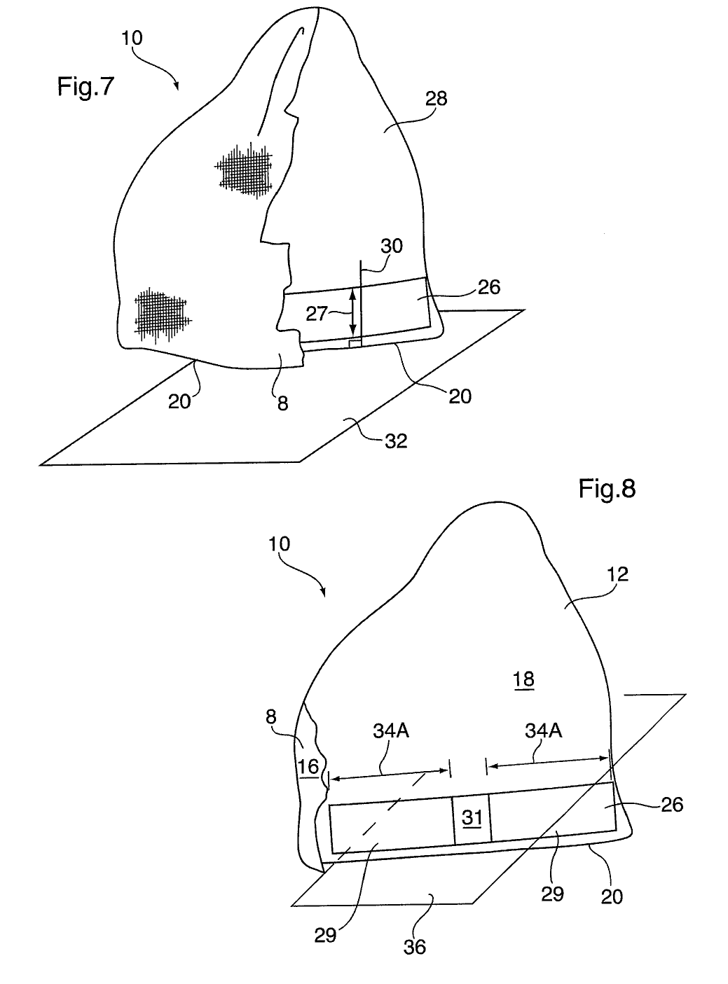

In some embodiments, for example, the lower portion 26 may also include at least one lower portion filler textile material portion 31 (see FIG. 8). A suitable lower portion filler textile material portion is any kind of textile material, including any fabric made through weaving, knitting, crocheting, or bonding, so long as the textile material includes less than 10 volume % of the operative material based on the total volume of the lower portion filler textile material portion. For example, the lower portion filler textile material portion does not include any operative material. For example, the lower portion filler textile material portion is knitted merino wool.

In some embodiments, for example, and referring to FIG. 8, the lower portion 26 may include alternating portions of lower portion operative textile material portion 29 and lower portion filler textile material portion 31.

The remainder portion 28 includes at least one remainder textile material portion. A suitable remainder textile material portion is any kind of textile material, including any fabric made through weaving, knitting, crocheting, or bonding, so long as the textile material includes less than 10 volume % of the operative material based on the total volume of the remainder textile material portion. In some embodiments, for example, the remainder textile material portion does not include any operative material. In some embodiments, for example, the interior surface remainder textile material portion is knitted merino wool.

In some embodiments, for example, the lower portion 26 extends substantially from the edge 20.

In some embodiments, for example, each of those portions of the lower portion 26 which are configured to extend above and behind the ears and across the forehead of the wearer of the headwear 10 are defined by a respective lower portion operative textile material portion.

In some embodiments, for example, the sum of the respective surface area of each one of the at least one operative textile material portion defines at least 15% of the surface area of the exterior surface 16 of the shell 12. In some embodiments, for example, the sum of the respective surface area of each one of the at least one operative textile material portion defines at least 15% of the surface area of the exterior surface 16 of the shell, and less than 50% of the surface area of the exterior surface 16 of the shell 12.

Referring to FIG. 7, in some embodiments, for example, each one of the at least one lower portion operative textile material portion includes a minimum width 27 of at least 1.5 inches measured along an axis 30 which is normal to the plane 32 parallel to the edge 20.

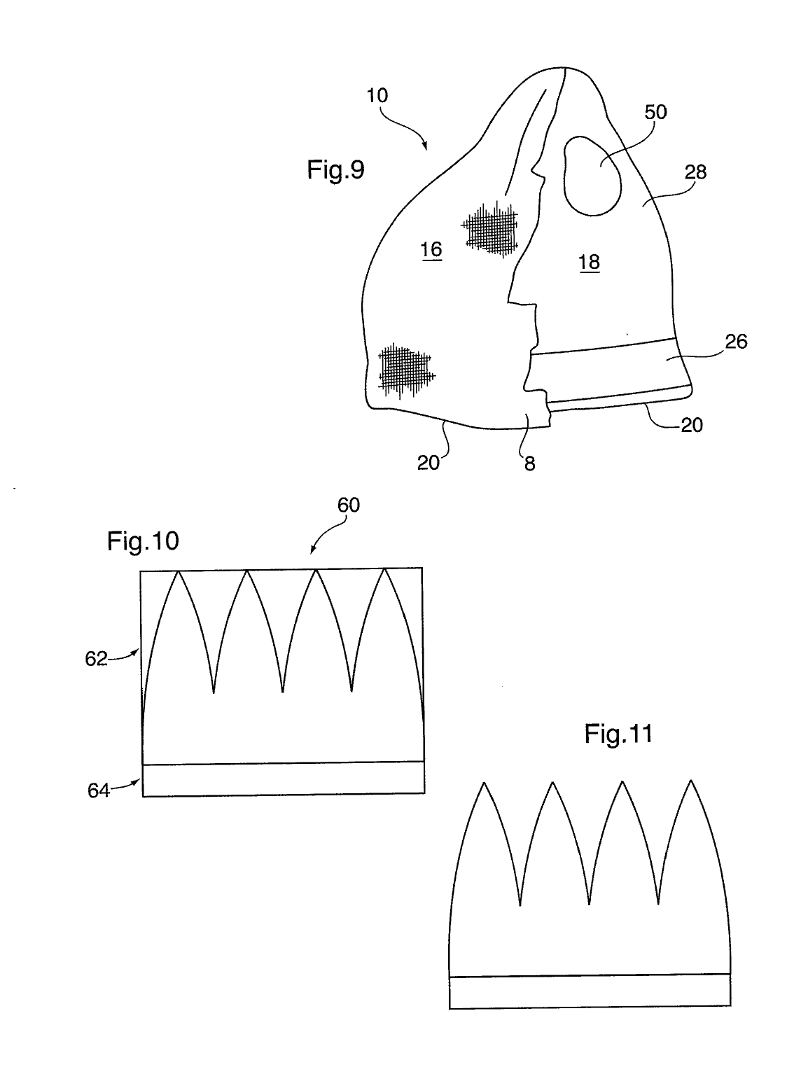

Referring to FIG. 9, in some embodiments, in addition to including a lower portion 26 and a remainder 28, the shell 8 further includes an upper operative textile material portion 50. The portion 26 and the remainder 28 are as defined above. The upper operative textile material portion 50 is disposed above the lower portion 26. The upper operative textile material portion 50 is any kind of textile material, including any fabric made through weaving, knitting, crocheting, or bonding, so long as the textile material includes at least 10 volume % of the operative material based on the total volume of the upper operative textile material portion 50. In some embodiments, for example, the upper operative textile material portion 50 consists essentially of the operative material.

It is believed that use of the effective material in the headwear 10 may provide benefits to persons who wear the headwear. There are suggestions in the publicly available literature that use of an embodiment of the effective material in clothing assists in oxygenation of the transcutaneous tissues of a human body when the clothing is worn next to the skin. It is believed that wearing of the headwear 10 may promote oxygenation of transcutaneous tissues in the scalp region via increased blood perfusion of those transcutaneous tissues. In this respect, it has been suggested that increased oxygenation to the scalp may stimulate hair follicles (see, for example, www.salonweb.com/follicare.htm, www.ishrs.org/articles/hair-follicle-cloning.htm, and www.lef.org/magazine/mag97/march-cover97.html.)

The headwear 10 may be manufactured using conventional manufacturing processes. For example, head fitting portion textile material, in the form of yarn, is fed into an industrial knitting machine, and is then consecutively followed by material band portion textile material, which is also fed into the industrial knitting machine, to form a panel 60 (see FIG. 10) consisting of an upper band 62 of head fitting portion textile material and a lower band 64 of material band portion textile material. For example, the textile material of the panel is in the form of a jersey stitch (also known as a stocking stitch). The panel is then cut (die-cut, or laser cut, or cut by hand) to form a four dart configuration (see FIG. 11). The lower band is folded over and coupled to the upper band by a blind hem, to form the material band portion 14. The edges of the dart configuration are then serged together so that the headwear 10 assumes its intended form.

Further embodiments will now be described in further detail with reference to the following non-limitative example.

### Example

An experiment was conducted to compare the effect on blood perfusion as between different headwear worn on a human head, each one of the headwear being comprised of different fiber material.

### Subjects

Twenty-three college-aged (mean=20 years) male subjects volunteered for the study. All subjects were considered of normal health with no identifiable diseases or conditions and without history of any major head, facial, or neck injury. All subjects were instructed to refrain from consuming any food or drink for at least four (4) hours prior to data collection as well as exercise or other physically exerting activity.

### Environment

The testing occurred in a climate controlled situation that maintain constant temperature and was free of distraction. Temperature was maintained at 76(SD±2) degrees Fahrenheit. Ambient light was normal with high ceiling lighting and no spot lighting. Background noise was non-existent.

### Data Collection

Blood flow perfusion to the scalp was measured via laser Doppler flowmetry (LDF). The LDF100C (Biopac Systems Inc.) collection module utilizing the manufacturer's calibrated surface laser light probe, TSD140 series probe (Biopac Systems, Inc) was attached to the hardware data collection device MP150 (Biopac Systems, Inc). The device manufacturer's software, AcqKnowledge, was used to filter and analyze the data in blood perfusion units (BPUs). Measurements were taken for baseline and for each treatment in the last minute of acclimatization for ten seconds, recording the mean. The hardware was connected to a Dell Latitude laptop.

### Treatment

Each subject wore six (6) different caps. Each one of the six caps was manufactured from a different respective material. The six materials were cotton, treated cotton, acrylic, treated acrylic, and a fiber material including optically active particulate materials supported on a support material (hereinafter “Optically Active Material”, and more particularly described in Appendix “A”) and treated Optically Active Material. Each of the “treated materials” were treated by spraying a Spray Composition, the Spray Composition being more particularly described in Appendix “A”. The caps were all constructed in the same manner, size, and shape.

### Procedures

The study was a double blind randomized control. Subjects entered a climate controlled room (76±2 degrees Fahrenheit) and remained seated in the testing chair for a minimum of ten minutes prior to testing. This was to be sure acclimatization occurred and there was no apparent perspiration. The diode (TSD140 series probe) was secured to the frontal lobe region approximately 3.5 cm above the superior portion of the nasal bone via the self adhesive diode tape. Subjects were instructed to remain quiet and were not allowed to speak or consume any food or beverage. The cable was also secured to the subject to reduce any movement. Base line measurements were taken prior to the application of the caps. Each cap included a hole punch of approximately 2 cm in diameter where they were secured to the subject over the diode. This allowed the diode to remain pressure free, as the diode and microvascular flow are extremely sensitive to pressure. This also eliminated any influence of the sprayed-on composition in disturbing the readings. Caps were applied in random order and a new cap was used for each subject's treatment condition. All subjects received new caps for each application. Three minutes of acclimatization occurred between applications and removal of all caps and BPU was constantly monitored.

### Analysis

Data analysis was performed on the blood flow perfusion units (BPU). The comparison of each treatment was to baseline as a T-TEST and significance set to p<0.05.

### Results

Table 1 provides the t-test results of the study compared to baseline. The treated cotton was approaching significance (p=0.058), however, the treated Optically Active Material has the only significant increase over all other treatment situations (p=0.03). The only other statistical significance is the treated Optically Active Material compared to non-treated acrylic (p=0.03). Table 1 and FIG. 1 also provide percentage difference in the caps compared to baseline.

TABLE 1
TTest to Baseline and Percent Differences

| T COT | T POLY | T ACRYL | C COT | C POLY | C ACRYL |
|---|---|---|---|---|---|
| Ttest Base | Ttest Base | Ttest Base | Ttest Base | Ttest to Base | Ttest to Base |
| 0.05 | 0.03 | 0.12 | 0.18 | 0.09 | 0.32 |
| | | | | % Increase | % Increase |
| % over Base | % over Base | % over Base | % over Base | over Base | over Base |
| 14.84 | 16.69 | 13.55 | 8.82 | 11.72 | 2.41 |

T = treatment,
C = untreated,
COT = Cotton,
POLY = Optically Active Material,
ACRYL = Acrylic

### Discussion

All caps resulted in an increase in blood flow perfusion, however only the treated Optically Active Material was statistically significant over the caps.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

### APPENDIX “A”

“Optically Active Material”, as referred to in the Example, is HOLOFIBER™ supplied by Hologenix, LLC, c/o Celliant of Santa Monica, Calif. (the HOLOFIBER™ material is also sold under the name CELLIANT™).

“Spray Composition”, as referred to in the Example, is a sprayable composition available from Kentucky Textiles, LLC of Paris, Ky. The exact composition of the sprayable composition was not known, but it is believed that such composition can be broadly characterized as comprising: 0.1% to 5.0% polyolefin, 0.1% to 5.0% wetting agent, 0.0% to 8.0% aminofunctional silicone, 0.0% to 6.0% ionizing agent, 0.0% to 2.0% catalyst, and including a pH of between 2.0 and 4.0.

1. A fiber material whose production is effected by contacting a fiber substrate with an operative composition;
wherein the fiber substrate includes optically active particulate materials supported on a support material;
and wherein the operative composition comprises 0.1% to 10% cross-linking agent, 0.1% to 5.0% polyolefin, 0.1% to 5.0% wetting agent, 0.0% to 8.0% aminofunctional silicone, 0.0% to 6.0% ionizing agent, 0.0% to 2.0% catalyst, and includes a pH of between 2.0 and 4.0.

2. The fiber material as claimed in claim 1, wherein the fiber substrate is configured to absorb light at a first wavelength and re-emit light at a second wavelength.

3. The fiber material as claimed in claim 1, wherein the support material of the fiber substrate includes a polymeric resin.

4. The fiber material as claimed in any one of claims 1, wherein the optically active particulate materials of the fiber substrate include at least one of aluminium oxide, silicon dioxide and titanium dioxide.

5. The fiber material as claimed in claim 4, wherein the optically active particulate materials of the fiber substrate include a particle size of less than 2 microns.

6. The fiber material as claimed in claim 5, wherein the operative composition further includes a carrier.

7. The fiber material as claimed in claim 6, wherein the cross-linking agent of the operative treatment composition is any one of a polycarboxylic acid, a low molecular weight polymaleic acid, a copolymer of maleic acid and other monmers, citric acid, butanetetracaborlyxic acid, and mixtures of thereof.

8. The fiber material as claimed in claim 7, wherein the polyolefin of the operative treatment composition is any one of polyethylene, polypropylene, and mixtures thereof.

9. The fiber material as claimed in claim 8, wherein the wetting agent of the operative treatment composition is any one of non-ionic and anionic surfactants and mixtures thereof.

10. The fiber material as claimed in claim 9, wherein the aminofunctional silicone of the operative treatment composition is ionizeable.

11. The fiber material as claimed in claim 10, wherein the aminofunctional silicone of the operative treatment composition is a silicone polymer including amine groups.

12. The fiber material as claimed in claim 11, wherein the ionizing agent is any one of choline chloride, other reactive quarternary compounds, and mixtures thereof.

13. The fiber material as claimed in claim 12, wherein the catalyst is any one of sodium hypophosphite, sodium phosphate, sodium hydroxide, sodium carbonate, and mixtures thereof.

14. The fiber material as claimed in claim 6, wherein the carrier is any one of water, air, alcohol, water soluble compounds, and mixtures thereof.

15. The fiber material as claimed in claim 14, wherein the contacting is effected by spraying the operative composition onto the fiber substrate in a dense soaking mist.

16. The fiber material as claimed in claim 15, wherein the contacting is effected by applying the operative composition with the fiber substrate using an open paddle wheel.

17. The fiber material as claimed in claim 16, wherein the contacting is effected by applying the operative composition onto the fiber substrate in a pressure dye vessel.

18. A fabric material comprising the fiber material as claimed in claim 17.

19. The fabric material as claimed in claim 18, wherein the fabric material includes at least 10 volume % of the fiber material based on the total volume of the fabric material.

20. Headwear including the fabric material as claimed in claim 19.
